(19) United States
(12) Patent Application Publication
(10) Pub. No.: US 2024/0165779 A1
(43) Pub. Date: May 23, 2024

(54) TOOL BIT EXTRACTOR

(71) Applicant: MILWAUKEE ELECTRIC TOOL CORPORATION, Brookfield, WI (US)

(72) Inventor: Travis J. DuMez, Port Washington, WI (US)

(21) Appl. No.: 18/551,552

(22) PCT Filed: Apr. 8, 2022
(86) PCT No.: PCT/US2022/023988

§ 371 Date: Sep. 20, 2023

Related U.S. Application Data
(60) Provisional application No. 63/175,663, filed on Apr. 16, 2021.

(51) Int. Cl. B25B 27/18

(52) U.S. Cl. CPC B25B 27/18

(57) ABSTRACT

A tool bit extractor for removing a drill bit stuck in a workpiece. The tool bit extractor includes a shaft with a first end, a second end opposite the first end, and a longitudinal axis extending between the first and second ends. The tool bit extractor also includes a cap assembly disposed at the first end of the shaft and a bit retention assembly disposed at the second end of the shaft. The bit retention assembly includes an opening configured to receive the drill bit. The tool bit extractor further includes a handle with a mass. The handle is moveable relative to the shaft between the first and second ends.

### CROSS REFERENCE TO RELATED APPLICATION

This application claims the benefit of co-pending U.S. Provisional Patent Application No. 63/175,663 filed on Apr. 16, 2021, the entire content of which is incorporated herein by reference.

### FIELD OF THE INVENTION

The present invention relates to a tool bit extractor for the removal of, for example, a drill bit stuck in a workpiece.

### BACKGROUND OF THE INVENTION

Drill bits, such as masonry drill bits, are used with power tools (e.g., rotary drills or hammer-type drills) to cut through a workpiece. Occasionally, while drilling through harder workpieces, the drill bit will become stuck. There are methods and tools to assist in the removal of drill bits that are stuck in concrete or harder materials. However, removal of a drill bit stuck in concrete is especially difficult for drill bits that include SDS, SDS+, or SDS max shanks.

### SUMMARY OF THE INVENTION

In one embodiment, the invention provides a tool bit extractor for removing a drill bit stuck in a workpiece. The tool bit extractor includes a shaft with a first end, a second end opposite the first end, and a longitudinal axis extending between the first and second ends. The tool bit extractor also includes a cap assembly disposed at the first end of the shaft and a bit retention assembly disposed at the second end of the shaft. The bit retention assembly includes an opening configured to receive the drill bit. The tool bit extractor further includes a handle with a mass. The handle is moveable relative to the shaft between the first and second ends.

In another aspect, the mass is moveable from the second end to the first end to impact the cap assembly.

In another aspect, the cap assembly includes an abutting surface that limits axial movement of the handle along the longitudinal axis.

In another aspect, the mass is disposed within a bore of the handle.

In a further aspect, the mass is concentric with the longitudinal axis.

In another embodiment, the invention provides a method of removing a drill bit from a workpiece using the tool bit extractor.

In another embodiment, the invention provides a tool bit extractor for removing a tool accessory stuck in a workpiece. The tool bit extractor includes a shaft having a first end, a second end opposite the first end, and a longitudinal axis extending between the first and second ends. The tool bit extractor also includes a cap assembly disposed at the first end of the shaft and a bit retention assembly disposed at the second end of the shaft. The bit retention assembly is configured to receive the tool accessory. The tool bit extractor further includes a mass moveable relative to the shaft between a first position, in which the mass is near the cap assembly, and a second position, in which the mass impacts the cap assembly to facilitate removal of the tool accessory.

In another embodiment, the invention provides a method of removing a tool accessory stuck in a workpiece using a tool bit extractor. The tool bit extractor includes a shaft, a cap assembly at one end of the shaft, a bit retention assembly disposed at an opposite end of the shaft, and a mass disposed on the shaft. The method includes securing the bit retention assembly to the tool accessory, positioning the mass near the bit retention assembly, rapidly moving the mass in a direction along the shaft and away from the bit retention assembly, and impacting the mass against the cap assembly, causing the bit retention assembly to impart a pulling force on the stuck drill bit.

Other aspects of the invention will become apparent by consideration of the detailed description and accompanying drawings.

### BRIEF DESCRIPTION OF THE DRAWINGS

FIG. 1 is a perspective view of a tool bit extractor.

FIG. 2 is an exploded view of the tool bit extractor of FIG. 1.

FIG. 3 is a cross-sectional view of the tool bit extractor of FIG. 1 taken along lines 3-3.

FIG. 4 is a perspective, cross-sectional view of one end of the tool bit extractor of FIG. 3.

FIG. 5 is a perspective, cross-sectional view of another end of the tool bit extractor of FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

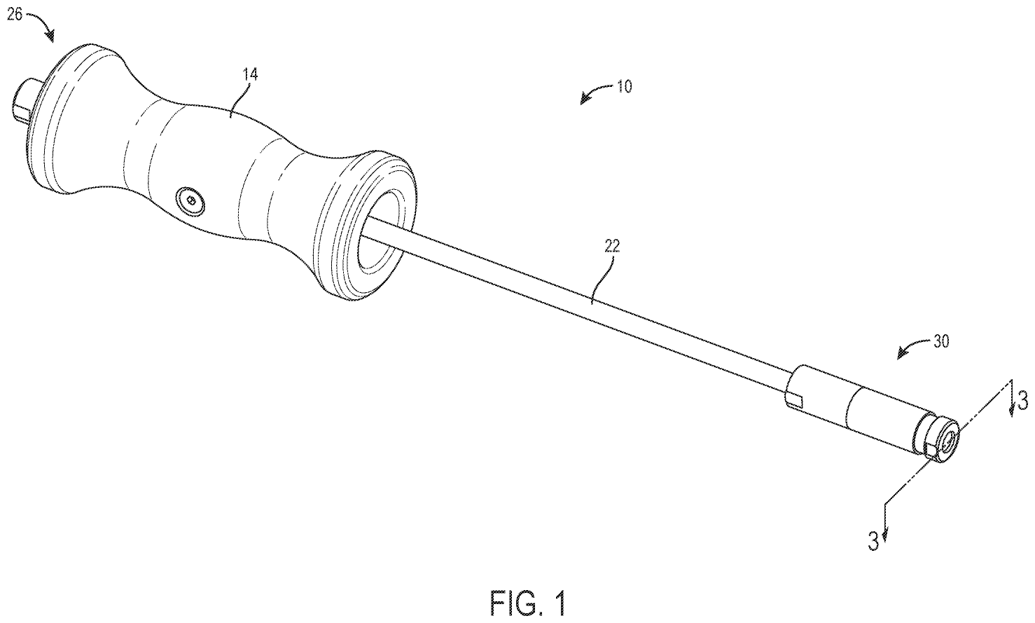

FIGS. 1-3 illustrate a tool bit extractor 10 used to remove tool bits and other tool accessories that become stuck within a workpiece, such as, for example, brick, block, tile, metal, marble, concrete, plaster, wood, plastic, dry-wall, rebar and the like. For example, the tool bit extractor 10 may be used to remove drill bits from a workpiece. As such, the tool bit extractor 10 may also be referred to as a drill bit extractor or simply a bit extractor. In some embodiments, the tool bit extractor 10 is particularly operable to remove SDS type drill bits such as SDS+ and SDS Max drill bits that are typically more difficult to remove from harder materials.

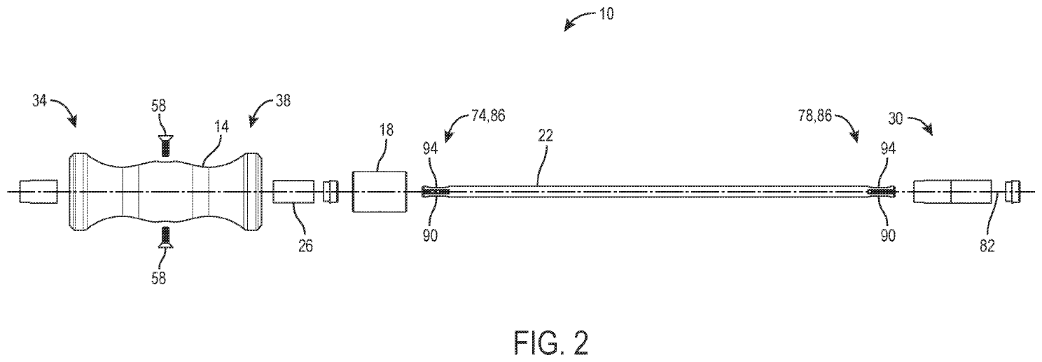

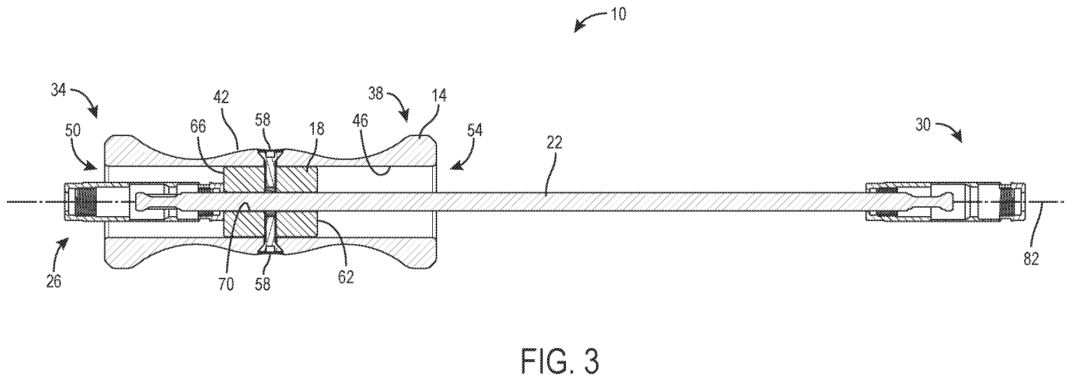

With reference to FIGS. 2 and 3, the bit extractor 10 includes a handle 14, a weight or mass 18 disposed within the handle 14, a shaft 22, a cap assembly 26, and a bit retention assembly 30. The handle 14 includes a first end 34, a second end 38 opposite the first end 34, and a body 42 extending between the first and second ends 34, 38. The body 42 defines a grip for a user to grasp during operation of the bit extractor 10. In the illustrated embodiment, the body 42 is contoured to facilitate grasping and manipulating the handle 14. In other embodiments, the body 42 may have other features to facilitate grasping, such as a ribbed or knurled outer surface. Moving to FIG. 3, a bore 46 extends through the body 42 between the first and second ends 34, 38 of the handle 14. The handle 14 also includes a first opening 50 extending into the bore 46 at the first end 34 and a second opening 54 extending into the bore 46 at the second end 38. The weight 18 is disposed within the bore 46 and is coupled to the handle 14 with fasteners 58 (e.g., screws). The illustrated weight 18 is a separate element from the body 42 that increases the overall weight or mass of the handle 14, apart from the material of the handle 14 itself. For example, the weight 18 may be a piece of relatively heavy material, such as a dense metal, while the handle 14 is plastic. In the illustrated embodiment, the weight 18 is fixed relative to the handle 14 within the bore 46. In other embodiments, the weight 18 may be moveable within the bore 46 between the first and second ends 34, 38 of the handle 14. In further embodiments, the weight 18 may be removable from within the bore 46 of the handle 14. The weight 18 includes a front end 62, a rear end 66 opposite the front end 62, and a longitudinal hole 70 extending through the weight 18 between the front and rear ends 62, 66.

With reference back to FIG. 2, the shaft 22 includes a first end 74, a second end 78 opposite the first end 74, and a longitudinal axis 82 extending between the first and second ends 74, 78 that defines an axis of the bit extractor 10. Each end 74, 78 of the shaft 22 defines a shank 86 that may be coupled with a rotary power tool such as a rotary drill or rotary hammer drill. In the illustrated embodiment, each shank 86 includes a pair of ball detents 90 and a pair of slots 94 (although only one ball detent 90 and one slot 94 is shown at each end 74, 78 of the shaft 22 in FIG. 2). For each shank 86, the ball detents 90 are on diametrically opposite sides of the longitudinal axis 82 from one another. Similarly, the slots 94 are on diametrically opposite sides of the longitudinal axis 82 from one another other. In some embodiments, each shank 86 of the shaft 22 may only include a single ball detent 90 and/or a single slot 94, or each shank 86 may include more than two ball detents 90 and/or slots 94. Each illustrated ball detent 90 is positioned 90 degrees circumferentially from an adjacent slot 94 and vice versa. The ball detents 90 are configured to receive a locking ball of a power tool to couple one of the shanks 86 to a power tool. The slots 94 are configured to receive a pin of a power tool to fix rotational movement of the shaft 22 relative to a chuck of the power tool. In other embodiments, the shaft 22 may not include the ball detents 90 and/or the slots 94. Instead, the shaft 22 may be a relatively simple, cylindrical shaft without additional features.

As shown in FIG. 3, the first end 74 of the shaft 22 is received within the bore 46 of the handle 14. Specifically, the first end 74 of the shaft 22 extends through the longitudinal hole 70 of the weight 18 and into the cap assembly 26 so that the shank 86 at the first end 74 is disposed within the cap assembly 26. In the illustrated embodiment, the handle 14 is moveable relative to the shaft 22 along the longitudinal axis 82 in order to oscillate the weight 18 which facilitates removal of a stuck drill bit, as will be described in more detail below: Additionally, the handle 14 may be rotatable relative to the shaft 22 about the longitudinal axis 82.

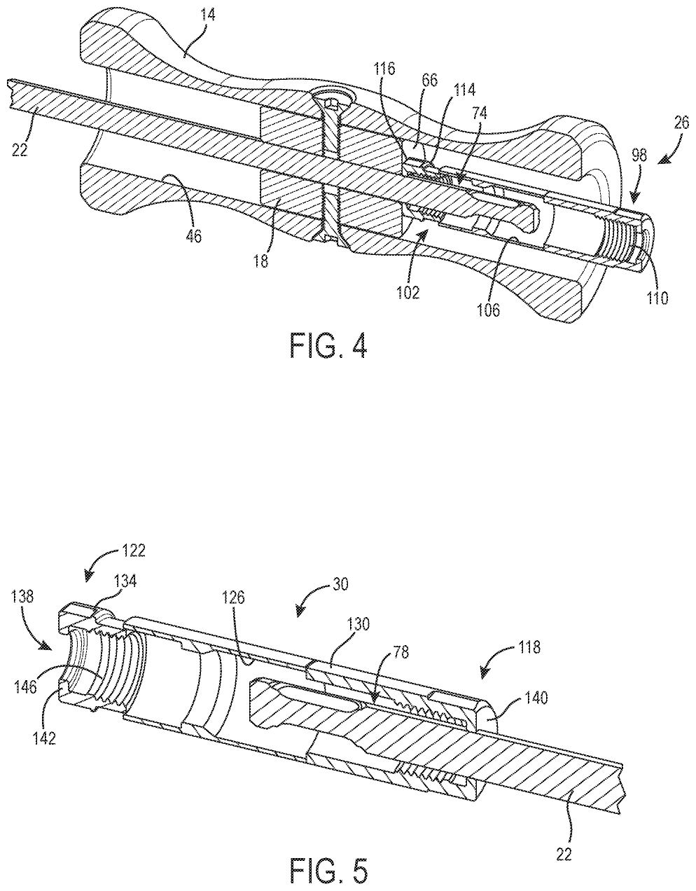

With reference to FIG. 4, the cap assembly 26 is disposed at the first end 74 of the shaft 22. The cap assembly 26 includes a first end 98, a second end 102 opposite the first end 98, and a bore 106 extending between the first and second ends 98, 102. The first end 74 includes a threaded surface 110 extending circumferentially within the bore 106. The second end 102 defines a retainer 114 that secures the cap assembly 26 to the first end 74 of the shaft 22. The retainer 114 includes an abutting surface 116 that engages the rear end 66 of the weight 18 to limit the axial movement of the handle 14 relative to the shaft 22 along the longitudinal axis 82.

In some embodiments, the cap assembly 26 may be fixed to the first end 74 of the shaft 22. In other embodiments, the cap assembly 26 may be coupled to the shaft 22 by a friction fit engagement, fasteners, welding, brazing, or the like. In further embodiments, the cap assembly 26 may be removable from the shaft 22 and replaced with a different cap assembly 26, for instance, if the cap assembly 26 was damaged.

With reference to FIG. 5, the bit retention assembly 30 is disposed at the second end 78 of the shaft 22. The bit retention assembly 30 includes a first end 118, a second end 122 opposite the first end 118, and a bore 126 extending between the first and second ends 118, 122. The first end 118 of the bit retention assembly 30 defines a sleeve 130, and the second end 122 defines a bit retainer 134 with an opening 138 to receive a stuck bit. The sleeve 130 secures the bit retention assembly 30 to the second end 78 of the shaft 22. The sleeve 130 includes an abutting surface 140 that engages the front end 62 of the weight 18 to limit the axial movement of the handle 14 relative to the shaft 22 along the longitudinal axis 82. The bit retainer 134 includes a lip 142 and a threaded surface 146 extending circumferentially within the bore 126. Both the lip 142 and the threaded surface 146 engage a stuck bit to facilitate removal of the bit from a workpiece. In some embodiments, the bit retainer 134 may engage and secure a drill bit within the bore 126 of the bit retention assembly 30 in other manners. For example, a drill bit may frictionally engage with an inside surface of the bore 126. Alternatively, the bit retainer 134 may be threadably coupled to the sleeve 130. The bit retainer 134 may then be rotated relative to the sleeve 130 to couple the drill bit to the bit retention assembly 30.

In some embodiments, the bit retention assembly 30 may be fixed to the second end 78 of the shaft 22. In other embodiments, the bit retention assembly 30 may be coupled to the shaft 22 by a friction fit engagement, fasteners, welding, brazing, or the like. In further embodiments, the bit retention assembly 30 may be removable from the shaft 22 and replaced with other bit retention assemblies that accommodate drill bits of different sizes, shapes, types, etc.

As mentioned above, the opening 138 of the bit retainer 134 receives a stuck bit. As such, the opening 138 and the bit retention assembly 30 may be configured to receive drill bits of different sizes. For example, possible sizes of drill bits to be received by the bit retention assembly 30 may be ⅛″, ¼″, ⅜″, and ½″. In some embodiments, the opening 138 of the bit retention assembly 30 may receive a drill bit the between ⅜″ and 1½″. In other embodiments, the opening 138 of the bit retention assembly 30 may receive a drill bit of other sizes.

In the illustrated embodiment, the bit retention assembly 30 and the cap assembly 26 are the same structure. Such an arrangement facilitates manufacture and assembly of the bit extractor 10 by reducing the number of different pieces that need to be created. For example, the same piece can be manufactured and then attached to either the first end 74 of the shaft 22 to act as the cap assembly 26 or the second end 78 of the shaft 22 to act as the bit retention assembly 30. In other embodiments, the bit retention assembly 30 and the cap assembly 26 may have different structures or configurations from each other.

During operation of the bit extractor 10, a user may position a drill bit that is stuck in a workpiece through the opening 138 at the second end 122 of the bit retention assembly 30. The lip 142 and the threaded surface 146 of the bit retention assembly 30 engage the stuck drill bit to couple the stuck drill bit to the bit extractor 10. The user then moves the handle 14 relative to the shaft 22 along the longitudinal axis 82 until the handle 14 is positioned adjacent the second end 78 of the shaft 22. Next, the user moves the handle 14, preferably with excessive force, in a direction from the second end 78 of the shaft 22 towards the first end 74 of the shaft 22 along the longitudinal axis 82. As the handle 14 nears the first end 74 of the shaft 22, the rear end 66 of the weight 18 will impact the abutting surface 116 of the cap assembly 26 causing the bit retention assembly 30 to impart a pulling force on the stuck drill bit. The pulling force will act to loosen the stuck drill bit from the workpiece. The impact of the weight 18 with the cap assembly 26 will also vibrate the bit extractor 10, helping to loosen the stuck bit. If needed, the handle 14 can again be moved from the second end 78 of the shaft 22 towards the second end 74 of the shaft 22 until the drill bit is removed from the workpiece.

Various features and advantages are set forth in the following claims.

What is claimed is:

1. A tool bit extractor for removing a drill bit stuck in a workpiece, the tool bit extractor comprising:
a shaft including a first end, a second end opposite the first end, and a longitudinal axis extending between the first and second ends;
a cap assembly disposed at the first end of the shaft;
a bit retention assembly disposed at the second end of the shaft, the bit retention assembly including an opening configured to receive the drill bit; and
a handle including a mass, the handle being moveable relative to the shaft between the first and second ends.

2. The tool bit extractor of claim 1, wherein the mass is moveable by a user from the second end to the first end to impact the cap assembly.

3. The tool bit extractor of claim 1, wherein the cap assembly includes an abutting surface that limits axial movement of the handle along the shaft.

4. The tool bit extractor of claim 3, wherein the bit retention assembly also limits axial movement of the handle along the shaft.

5. The tool bit extractor of claim 1, wherein the mass is disposed within a bore of the handle.

6. The tool bit extractor of claim 1, wherein the mass is concentric with the longitudinal axis.

7. The tool bit extractor of claim 1, wherein the mass is fixed to the handle.

8. The tool bit extractor of claim 1, wherein the handle is made from a first material and the mass is made from a second material that is different than the first material.

9. The tool bit extractor of claim 8, wherein the handle is made from a plastic material and the mass is made from a dense metal.

10. The tool bit extractor of claim 1, wherein either the first or second end of the shaft defines a shank operable to couple with a power tool.

11. The tool bit extractor of claim 1, wherein the bit retention assembly is removably coupled to the second end of the shaft.

12. A tool bit extractor for removing a tool accessory stuck in a workpiece, the tool bit extractor comprising:
a shaft including a first end, a second end opposite the first end, and a longitudinal axis extending between the first and second ends;
a cap assembly disposed at the first end of the shaft;
a bit retention assembly disposed at the second end of the shaft, the bit retention assembly configured to receive the tool accessory; and
a mass moveable relative to the shaft between a first position, in which the mass is near the cap assembly, and a second position, in which the mass impacts the cap assembly to facilitate removal of the tool accessory.

13. The tool bit extractor of claim 12, wherein the mass is positioned within a handle for movement with the handle.

14. The tool bit extractor of claim 13, wherein the mass is fixed to the handle.

15. The tool bit extractor of claim 13, wherein the handle is made from a first material and the mass is made from a second material that is different than the first material.

16. The tool bit extractor of claim 12, wherein the mass is concentric with the longitudinal axis for movement between the first and second positions.

17. The tool bit extractor of claim 12, wherein the bit retention assembly defines a bit retainer with an opening configured to receive the tool accessory.

18. A method of removing a tool accessory stuck in a workpiece using a tool bit extractor, the tool bit extractor including a shaft, a cap assembly at one end of the shaft, a bit retention assembly disposed at an opposite end of the shaft, and a mass disposed on the shaft, the method comprising:
securing the bit retention assembly to the tool accessory;
positioning the mass near the bit retention assembly;
rapidly moving the mass in a direction along the shaft and away from the bit retention assembly; and
impacting the mass against the cap assembly, causing the bit retention assembly to impart a pulling force on the stuck drill bit.

19. The method of claim 18, further comprising repeatedly moving the mass in the direction and impacting the mass against the cap assembly until the tool accessory is removed from the workpiece.

20. The method of claim 18, wherein moving the mass includes moving the mass concentrically along the shaft.
